(19) United States
(12) Patent Application Publication
(10) Pub. No.: US 2026/0067656 A1
(43) Pub. Date: Mar. 5, 2026

(54) PRESENTING CONTEXTUALLY RELATED DIGITAL PRESENTATIONS BASED ON A PROXIMITY OF MULTIPLE CHARACTER OBJECTS

(71) Applicant: Hallmark Cards, Incorporated, Kansas City, MO (US)

(72) Inventors: Phu Dang, Shawnee, KS (US); Gary Thomas Pratt, Lawrence, KS (US); Orlanda Dominic Lacy, Kansas City, MO (US); Kevin Weldon Swanson, Kansas City, MO (US)

(21) Appl. No.: 19/316,776

(22) Filed: Sep. 2, 2025

Related U.S. Application Data
(60) Provisional application No. 63/690,625, filed on Sep. 4, 2024.
(60) Provisional application No. 63/698,758, filed on Sep. 25, 2024.
(60) Provisional application No. 63/713,320, filed on Oct. 29, 2024.

(51) Int. Cl. A63H 3/28; B42D 15/02; H04W 4/80

(52) U.S. Cl. CPC H04W 4/80; B42D 15/022

(57) ABSTRACT

A playback device includes a speaker, a processor, one or more memories, a set of scene presentations stored in the memories (where each scene presentation is related to each other by a common situational context), an near-field reader configured to identify a plurality of character objects (where each character object is identifiable by a near-field tag); and embodied computer-executable instructions that, when executed, cause one or more scene presentations to be presented based on which character objects are within a proximity of the playback device.

### CROSS-REFERENCE TO RELATED APPLICATIONS

This Application claims the benefit of and incorporates be reference (1) U.S. Provisional Application No. 63/690,625 (entitled PROMPTED AUDIO PERSONALIZATION SYSTEM AND METHOD, having attorney docket No. 887-00043, and filed on Sep. 4, 2024); (2) U.S. Provisional Application No. 63/698,758 (entitled PROMPT-BASED SYSTEM AND METHOD FOR PRESERVING MEMORIES, having attorney docket No. 887-00048 and filed on Sep. 25, 2024); and (3) Provisional Application No. 63/713,320 (entitled PRESENTING CONTEXTUALLY RELATED DIGITAL PRESENTATIONS BASED ON A PROXIMITY OF MULTIPLE CHARACTER OBJECTS, having attorney docket No. 887-00047, and filed on Oct. 29, 2024). All three Applications are hereby incorporated by reference for all purposes.

### BACKGROUND

Current methods or systems of attempting to keep track of memories depend on smartphone, social-media, and remote-storage services. That regiment results in large, digital hordes of photos and video without emotional context about the captured moment. It does not capture narratives to connect with the content to make them emotionally relevant. Some current systems rely only on date, time, location, and or people data, making it difficult, if not impossible, to navigate and find a specific stored memory. Story data in this way presents privacy and security risks because one's data is stored in a third-party's services.

Prior attempts to try address useability and other issues have resulted in high costs, undesirable size, and other requirements that are incompatible with desirous features of small and low-cost consumer products. The behavior and desires of some consumers have changed to want a simplified and more intuitive digital memory-keeping system instead of systems that merely store photos or files in albums and scrapbooks. The complexities associated with navigating personal digital hoards are undesirable. Another shortcoming of the prior art is the lack of prompting, specifically, intentional prompting that prompts a user to provide impactful input. Such products do not inspire a story from a storyteller.

A need exists for a better memory-preservation system, one that helps users share emotionally relevant narratives, makes use of tangible objects within a home or other local objects that users have physical procession of and control over.

Moreover, a need exists for a playback device to playback scenes of a situational context (such as a movie, book, series, etc.) based on the presence and change of character objects that are within a close proximity to the playback device. Different scenes are played based on the presence, withdrawal, re-introduction, timing, and absence of character objects.

### BRIEF DESCRIPTION OF THE DRAWINGS

FIG. 1 depicts block diagrams of an illustrative memory-preservation system and accessory according to one embodiment of the disclosed technology; and

FIG. 2. depicts an illustrative physical embodiment of a memory-preservation system and accessories in accordance with embodiments of the disclosed technology.

FIG. 3. depicts another illustrative physical embodiment of a memory-preservation system and accessories in accordance with embodiments of the disclosed technology.

FIGS. 4-6 depict still other embodiments of a memory-preservation system and accessories in accordance with embodiments of the disclosed technology.

FIG. 7 depicts an illustrative playback device in accordance with an embodiment of the disclosed technology.

FIG. 8 depicts an illustrative operating environment suitable for practicing an embodiment of the disclosed technology.

FIG. 9 depicts an illustrative use case of an embodiment of the disclosed technology.

### DETAILED DESCRIPTION

### Memory Preservation and Accessing

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing or electronic process that may be performed using any combination of hardware, firmware, and/or software. For instance, various functions may be carried out by a processor executing instructions stored in memory. Some methods may also be embodied as computer-usable instructions stored on computer storage media.

Embodiments of the disclosed technology, among other things, help users better identify, capture and share stories of their experiences with others. One embodiment uses such as radio frequency identifiers (RFIDs), RFID readers, themed products, and prompts provided by a prompt engine. For example, a memory-preservation system stores recorded memories in one embodiment. The memory-preservation system is a tangible item with embedded electronics such as memory, an RFID reader, and the like. Each recording can be associated with an accessory. Each accessory is identifiable by a unique identifier, such as RFID tag. Bringing the accessory sufficiently close to the memory-preservation system triggers related functionality, such as the playing back of the memory fille associated with the accessory or recording a memory file associated with the accessory.

The memory-preservation system can be themed in one embodiment. Intelligent prompts can correspond to the theme of the memory-preservation system and help guide the user in recording a memory file. Each base unit can hold many unique stories. Users can choose an accessory to add or to find a story in the base unit. The prompts and design of the base units and accessories helps user identify the stories of their experiences to capture and share. Digital stories are contained within the base unit, which never leaves the user's possession, thereby reducing security and privacy risks. The theme and design of an accessory or base unit enable natural navigation of the stories.

The system described herein provides an improved way to preserve memories by helping the storyteller (the person with the stories to tell) to preserve them. The system uses a prompt engine to prompt users, thereby inspiring aspects of stories to be recorded and captured. The prompt engine fosters clearer articulation of a story. It leads a user to include relevant and meaningful aspects of the story.

The stories are associated with and retrievable by a tangible, emotional artifact (e.g., an “accessory”) that triggers playback of one or more stories when brought close to a recordation base station. This artifact simplifies story playback, allowing for improved, archiving, display of, and selection of available stories. The system described herein allows stories to be quickly located that are relevant to specific moments.

The disclosed technology utilizes power from a base station, offloading power requirements from the accessories. Each accessory can include an RFID tag that is animated by base station, conserving power. In some embodiments, each accessory item has a unique ID and metadata associated with a prompt engine.

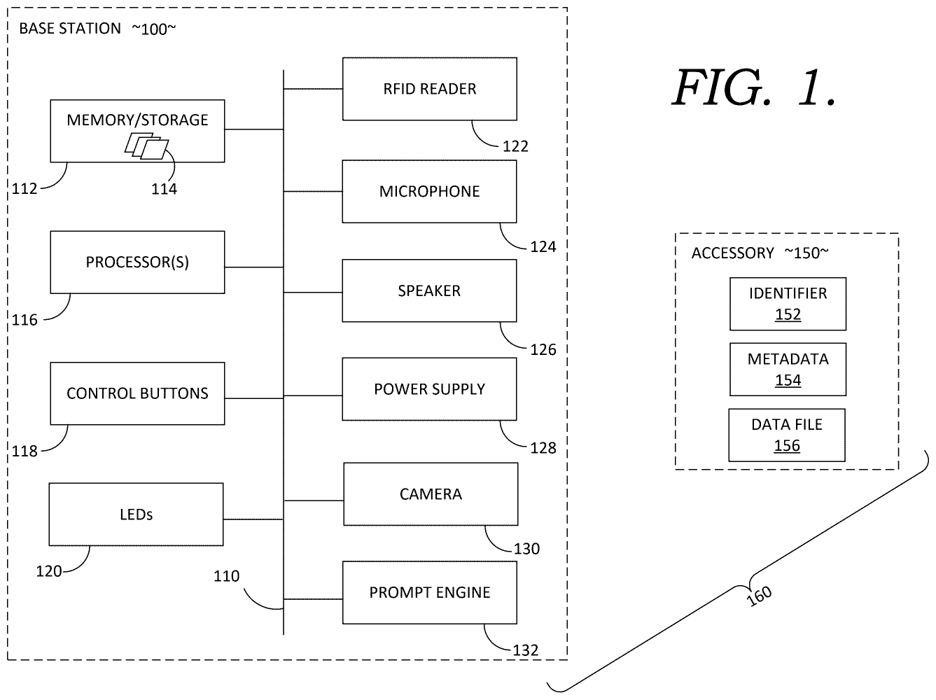

FIG. 1 depicts block diagrams of an illustrative base unit 100 (“storykeeper,” “storykeeper base,” “base station,” “base unit,” and the like) and of an accessory 150, which interacts with base unit 100. In one embodiment, base unit 100 includes one or more memory or storage media 112. This can include computer-storage media such as solid-state storage media, an SD card, or other storage media. The storage media 112 is suitable for storing computer-executable instructions suitable for executing programmatic instructions to carry out the functional aspects of the invention. It 112 can also be used to store memory files 114. Memory files 114 can be audio or video files, such as .WAV, .MP3, .MOV, .MPEG or other types of audio of video files.

One or more processors 116 control reading, processing computer-executable instructions and facilitating output.

One or more control buttons 118 control functional aspects of embodiment of the invention. For example, a first control button can be used to record, playback, or receiving information about memory files. In one embodiment, a first control button can perform a first function when pressed and released, a second function when held down for a certain duration, a third function when held down a different duration, and a fourth function when double pressed.

LEDs (or equivalents) 120 can provide status or feedback to a user. For example, it (or they) could blink to indicate that base unit 100 is recording a message, or remain lit to show the presence of power, or periodically blink to show charge, etc.

RFID reader 122 is suitable to read RFID tags when they are brought within a sufficient proximity to reader 122. It can facilitate providing power to enable a reading of a nearby RFID tag. Alternatively, reader 122 can read a QR code via camera 130.

Microphone 124 facilities recording audio. Speaker 126 outputs audio. Camera 130 can be used to record video or to recognize a pattern that takes the form of a unique identifier such as a QR code. In some embodiments, however, a camera is specifically not included (especially when greater simplicity is desired).

Power supply 128 can be one or more batteries or represents a constant power supply such as being plugged in or otherwise connected to an external source of power.

A prompt engine 132 includes prompts and prompt categories that prompt users to help them record meaningful memories. In one embodiment prompt engine 132 includes a set of computer-executable instructions embodied on memory 112 and is adapted to emit a plurality of audible prompts via speaker 126. The base station can store multiple recordings. Prompt engine 132 can take on a variety of forms. Prompt engine 132 provides prompts to users, playing an important role in that it helps users identify and appreciate the emotional relevance or impact of certain times, places, or events.

The embodiments of the disclosed technology generally contemplate an offline system or environment that does not include access to the internet. That is, the various components and methods do not rely on or interact with the internet. This enhances privacy and security and provides a way for users to access stories or experience scenes without having to access a network connected to the internet. In a first format, prompt engine 132 could be token driven. This embodiment could include an immutable list of prompts identifiers. This list would define all possible prompts for the life of a collection. Base station 100 includes pre-recorded prompts for every prompt type on this list in one embodiment. When a user presents a tag to the keeper (e.g., brings an accessory 150 close to base station 100), base station 100 retrieves the respective prompt identifier and implements the corresponding prompt.

A second format of prompt engine 132 is being base-station driven. This embodiment includes an immutable list of story-teller types. This list identifies people with stories to record into a base station (i.e., a mom, son, best man, teacher, etc.). The base station includes a pre-recorded prompt for every type on the list in one embodiment. When an accessory is brought close to the base station, it retrieves the respective type identifier and performs the corresponding prompt.

A third format that prompt engine 132 may assume is user-guide oriented. For example, a sheet of paper or a book (etc.) can be included. The guide includes inspirations and examples for the storyteller to use the system.

A fourth format that prompt engine 132 includes select online aspects. In this embodiment, one or more web pages could be utilized, reachable via a unique identifier on the base station, station as a QR code. Scan the QR code directs the user to a web page, application, etc. that includes instructions or content relevant to the base station. This can provide an alternative way to view the memories stored on the base station or play them back.

The prompts of prompt engine 132 can also be realized in a variety of ways. Prompts can be stored in base station 100. They are presented to a user, asking specific questions based on the accessory brought to the base station. A database of prompts can be stored in the base station or, alternatively or additionally, in an accessory 150. In still other embodiments, an application can be used to present prompts. This can include a gamified experience. For example, each person of a couple could be asked the same question separately; but they would be allowed to hear each other's answers only after both have recorded each's answer.

The items of base unit 100 are coupled to each other by one or more busses 110.

A block diagram of accessory 150 shows it including an identifier 152, metadata, 154, and one or more data files 156 in one embodiment. Identifier 152 uniquely identifies accessory 150 to base unit 100. It can be an RFID tag, QR code, or other unique identifier. Metadata 154 can describe accessory 150 or the data it contains, such as data file 156. Data file 156 can be one or more audio or video files.

Base unit 100 and accessory 150 can take on a variety of physical forms. For example, base unit 100 could be an ornament, molded, die-cut plastic, papercraft products, a greeting card, a box, a cylinder, or any other shape. It is a tangible device that can be touched and interacted with. It can be themed, such as a snowflake, a seashell, a snow globe, a trophy etc. When themed, the memory will relate to the physical characteristics of the base unit. For example, if a trophy, the memory stored might be of a child recording how happy she was that her mother attended her final volleyball game during high school. If a snowflake, the recording may be of a one person relaying the story of meeting another during a snowstorm years ago. If a seashell, the memory might be a recording of a parent to a son, recounting building sandcastles on a beach.

The design of base unit 100 is intentionally kept simple. It is not meant to have the functionality of a computer or smartphone. As mentioned, those devices store thousands of upon thousands of photographs or data files, making identifying them arduous, difficult, and susceptible to attack when actually stored off the phone (with only thumbnails or local data representing the actual image). Here, base unit 100 stores one file, or possibly a few more. Each memory file is retrievable via accessory 150.

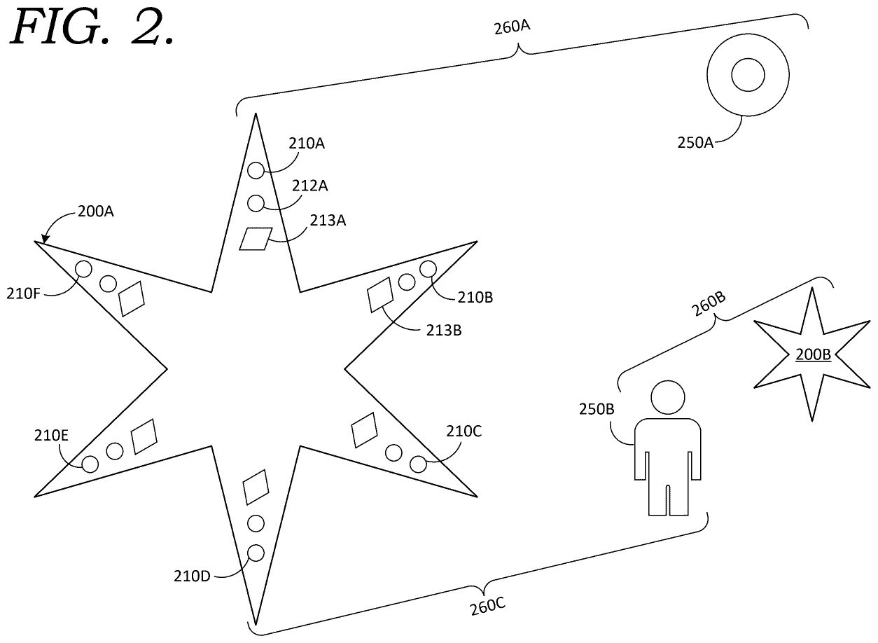

An illustrative physical embodiment of base units and accessories is depicted in FIG. 2, where like reference numerals correspond to similarly numbered items from FIG. 1. In FIG. 2, the illustrative base unit 200A takes the form of a six-sided snowflake. As mentioned, however, it could be a boat, a charm, a card, a ball, or any other physical object. In the embodiment shown, each branch of the snowflake can store a different memory, such as a different recorded audio file. Thus, this one device can store six memories, each respectively associated with a different accessory,

Buttons 210A-210F are useable to control functional aspects of memory keeper 200A. For example, if no file is recorded, then pressing button 210A may engage prompt engine 132 to prompt a user to record a file. Holding down button 210A may be used to record a file. Double pressing the button may playback a file. If a file is recorded, pressing, holding, etc. button 210A could have different functionalities. For example, pressing button 210A could play the recorded file. Holding button 210A a could starts a recording while the button is held down and end it when released. Double clicking button 210A could plays instructions to confirm erasing a recorded file, erase files when a double click occurs again within a prescribed timeframe (such as five seconds), or cancel or erase a recording. Other variations may also be used.

LEDs 212A (and other not labeled) are useable to provide feedback on operations. For example, LED 212A could blink when button 210A is pressed. Or LED 212A could continuously blink when recording is in progress. LED 212A could blink periodically to confirm that sufficient power exists to power base unit 200A. Data file 213A stores the story file for its arm. Similarly, data files 213B (and others not labeled) respectively store different data files associated with different accessories.

An illustrative accessory 250A takes the form of a small, crafted donut. It includes the features and components of accessory 150. Here, it will be associated with memory file 213A of memory keeper 200A. Another illustrative accessory 250B takes the form of a figurine. And it will be associated with memory file 213B. In some embodiments, accessories can be associated with multiple base units. For example, accessory 250B can also be associated with a different base unit 200B.

In an illustrative operation, button 210A can be held down to indicate a desire to record a message. Base unit 200A could audibly prompt the user to bring the desired accessory close to the base unit. Once the base unit senses the presence of, in this case accessory 250A, it could instruct the user to press button 210A to begin recording. A user would then record an audio message. When complete, it could be played back. If the user likes the recording, she could press button 210A again. Alternatively, she could double press (or hold down, etc.) button 210A to re-record the memory. Once complete, the memory recording is now associated with a given arm of snowflake 200A. When a user wishes to playback the memory, this can be done by bringing accessory 250A close to base unit 200A, which would automatically cause the memory to be played via its speaker.

If, for example, snowflake 200A belongs to the parents of six children, each child could use an accessory to record a different message. Each accessory might look physically different, optionally themed to the recorded memory. Each child would then give their accessories to their parents. The parents could then use each child's respective accessory to play a unique memory. And they would do so without having to search through a myriad of photographs, scroll through videos, find audio recordings, etc. Intentional design of such an embodiment leads to a novel ease of operation. It also keeps costs down and makes formats such as papercraft embodiments more feasible.

Because an accessory can be used with multiple base units, a child could record two different stories on two different base units and then gift the one accessory to a parent. The parent could then easily retrieve each story by simply bringing that child's accessory close to the different base units.

In some embodiments, the file to be played is stored on the accessory. And bringing the accessory close to a base unit allows the memory to be played via the base unit's speaker.

Instead of utilizing RFID, an accessory's identifier might be a QR code. During the recording process, a camera of the base unit is used to scan the QR code of the accessory. After the recording is made, it can be retrieved by using the camera of the base unit to scan the QR code of an accessory.

Another benefit of an embodiment of the disclosed technology is that it inspires storytellers to recognize the stories they want to remember or share and helps storytellers be more articulate in telling their stories. In one embodiment, storyteller 100 emits a series of prompts provided by prompt engine 132. For example, it can audibly provide prompts via speaker 126 to a user. The prompts guide user in what to record and how to record a story. For example, they may say “start by reminder the listener who you are,” leading a user to start with “Mom, this is Jane.”Other prompts provided by prompt engine 132 may be “be specific,” “say something funny if you want to invoke laughter,” “don't forget the punchline,” “close with a personal salutation.” These prompts help remind a storyteller of files in their collection. Here are other examples of prompt categories. The Story of Us. Looking back, reflect on shared memories, past challenges overcome, and joyful moments that have defined the relationship. Looking forward, discuss aspirations, future plans, and dreams, including where you see yourselves individually and as a couple in the years to come. In the moment, focus on the present, discussing current feelings, gratitude for each other, and ways to make the most of today. Little things, appreciate the small gestures and everyday moments that often go unnoticed but are the foundation of your connection. Growth together, explore how each of you has grown since being together, the lessons learned, and how you've influenced each other positively. Shared passions, delve into common interests, hobbies, and activities that bring you joy and bring you closer together. Challenges and triumphs, share the hurdles you've faced as a couple and celebrate the victories, no matter how big or small. Laughter and joy, recall the times that made you laugh uncontrollably, the inside jokes, and the quirky habits that endear you to each other. Dream destinations, talk about places you dream of visiting together, imagine the adventures you will have and the memories you will create. Legacy and impact, consider the mark you want to leave on the world as a couple, the values you want to pass on, and the impact you wish to have.

Here are examples of sample prompts provided by prompt engine 132: What was the first thing you noticed about (name)? What first attracted you to (name)? How did you both first meet? What made you decide to go on a second date? What is the most unexpected thing you have learned about each other over your time together? What is a special memory from the most recent trip you went on? What is a funny inside joke that only the two of you understand? What is your favorite part about (name)? What is one thing (name) does that drives you a little crazy? What is (name) just horrible at? What (name) always brings a smile to your face? What is a moment in your relationship that did not seem funny at the time but makes you laugh now Where do you see yourselves living in 10 years and why? Who is a better gift giver and why? What traditions do you want to start or continue in your family?

The embodiments described above reduce privacy and security risks by keeping the media within the home or otherwise not on internet-connected devices or services. Themed decorations invite the user to display these stories around their home instead of just storing them in a computer.

In an alternative embodiment, the base unit and accessories can be adapted for preloaded performances without an ability for users to capture their own content. In such an embodiment, accessory products are non-functional and have still have a unique identifier. The storyteller unit still includes an RFID reader (or equivalent). The storyteller would have pre-loaded performances (i.e. light, motion, sound, etc.). The performance respectively corresponds to and are invoked by respective accessories brought within a near proximity to the storyteller.

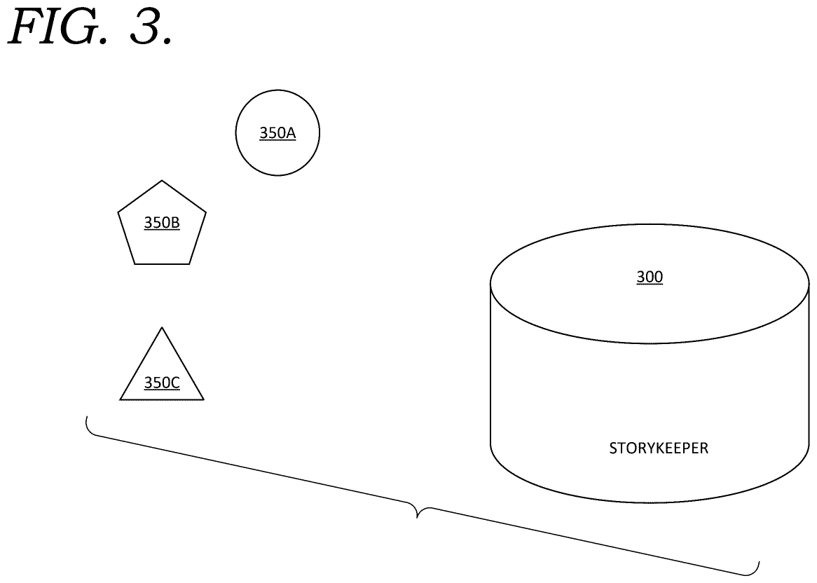

FIG. 3 depicts still another embodiment of the disclosed technology. FIG. 3 shows a base unit 300 that is similar to the other base units previously described. FIG. 3 also shows three different accessories, 350A, 350B, and 350C. Placing accessory 350A atop base unit 300 will cause it to play a first audio memory recording. But placing accessory 350B on base unit 300 will cause a different audio to be played. And placing accessory 350C on top of base unit 300 will cause still a different audio memory to be played. Instead of being placed actually on top of the base unit station, the accessories need only be brought within a sufficiently close proximity of the base unit. This can be configurable if desired, from, for example, a few inches to a few feet.

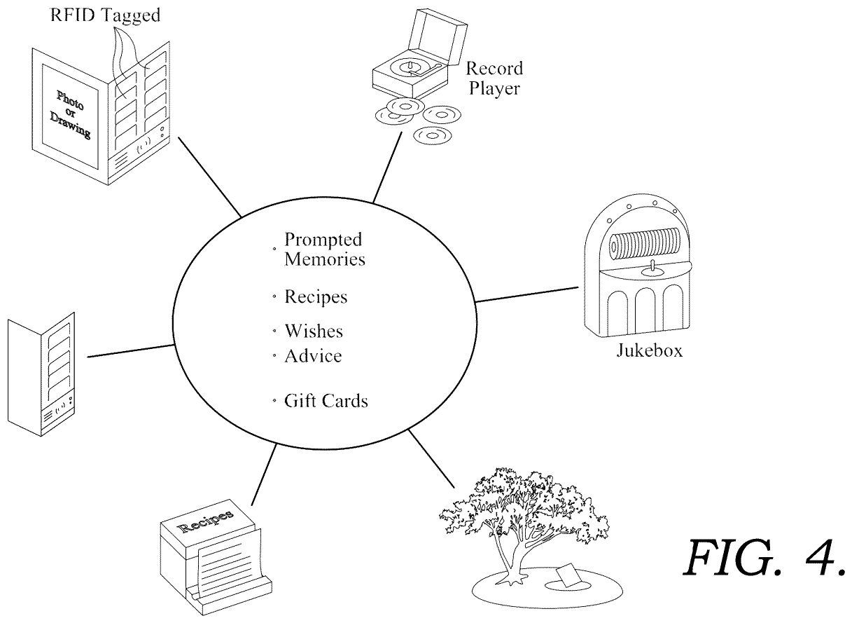

FIG. 4. provides other examples of other embodiments, where the base stations takes the form of a photo or drawing, a recipe holder, a tree with leaves as accessories, a jukebox, or a record player. Accessories are useable to identify and playback response to prompts, such as recipes, wishes, advice, etc.

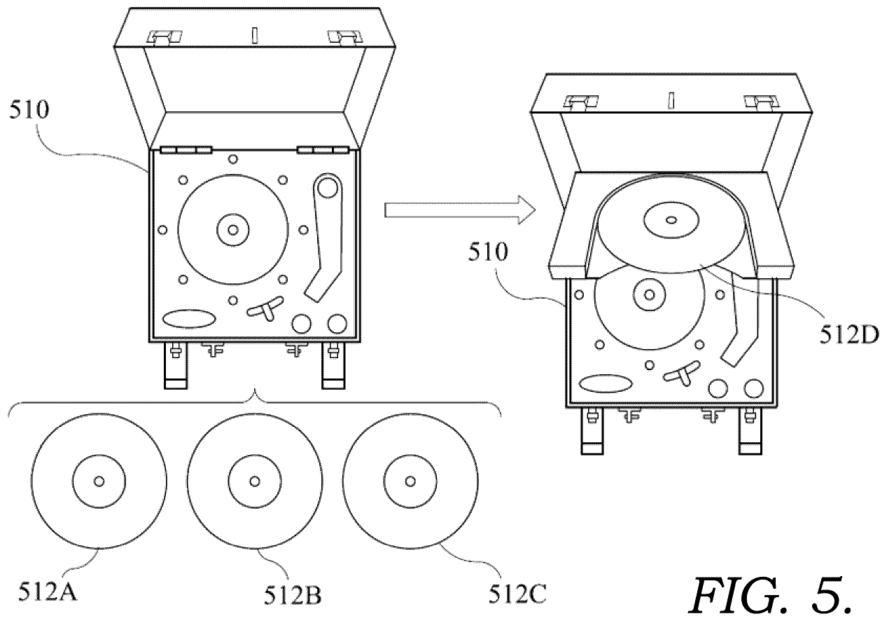

FIG. 5 shows an embodiment where the story keeper (such as base station 100 or 300) is a phonograph object and the accessories take the form of albums with respective RFID tags. This is an example of a themed base station that could retain “The Story of Us” for loved ones and take the form of a record player. It would enable couples, for example, to capture the story of their growing affection for each other, a parent and child to relive memories associated with meaningful songs, and the like.

This embodiment uses a small phonograph 510 that can “play” albums, such as 512A-512C. Each album can be associated with a respective memory. Couples can record answers to prompts that will bring them still closer together. Each album contains an RFID tag that can access a different audio file in one embodiment. The prompt can on the record label. An alternative format includes a jukebox.

Here, a user would chose an album with a question to be answered and place it on (or near) phonograph 510. The answer would be recorded (or re-recorded). Later, a specific album 512D can be “played” to hear the recorded answers. Playback can be activated by moving the needle arm over the album.

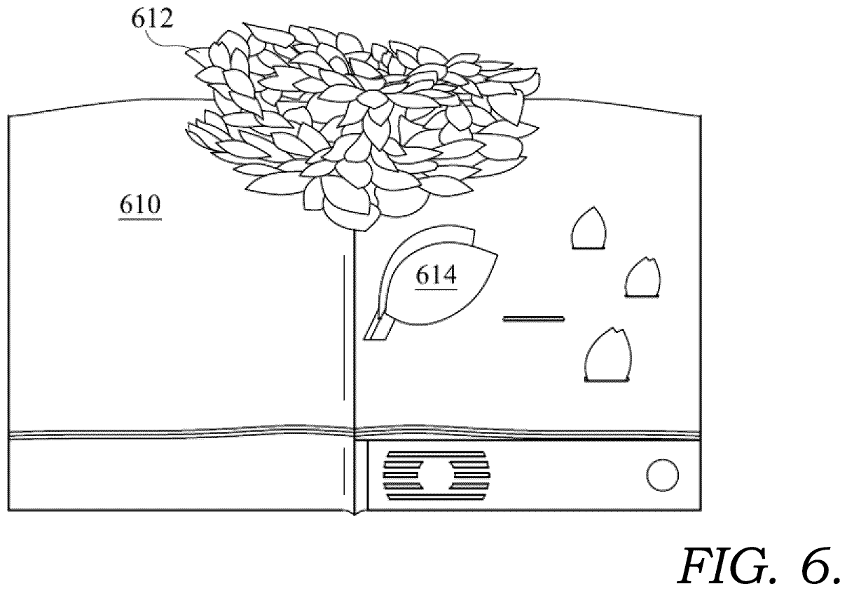

FIG. 6 shows an embodiment where the storyteller is a book 610 (or specific pages of a book) and the accessories are each respective petals 614 of a flower in the form of paper, for example with RFID tags embedded therein. The book could include a pop-up papercraft 612. Each petal 614 would be associated with a corresponding memory or person and could be useable to identify or recall memories. For example, in one embodiment, petal 614 corresponds to a certain child. It could include a picture of that child to clearly indicate that it represents the child. Bringing petal 614 near to the base station, which here, could be book 610, could lead to one or more memories associated with the child to be played. The petals could be physically stored in slits of pages of book 610.

### Intelligent Digital Presenting

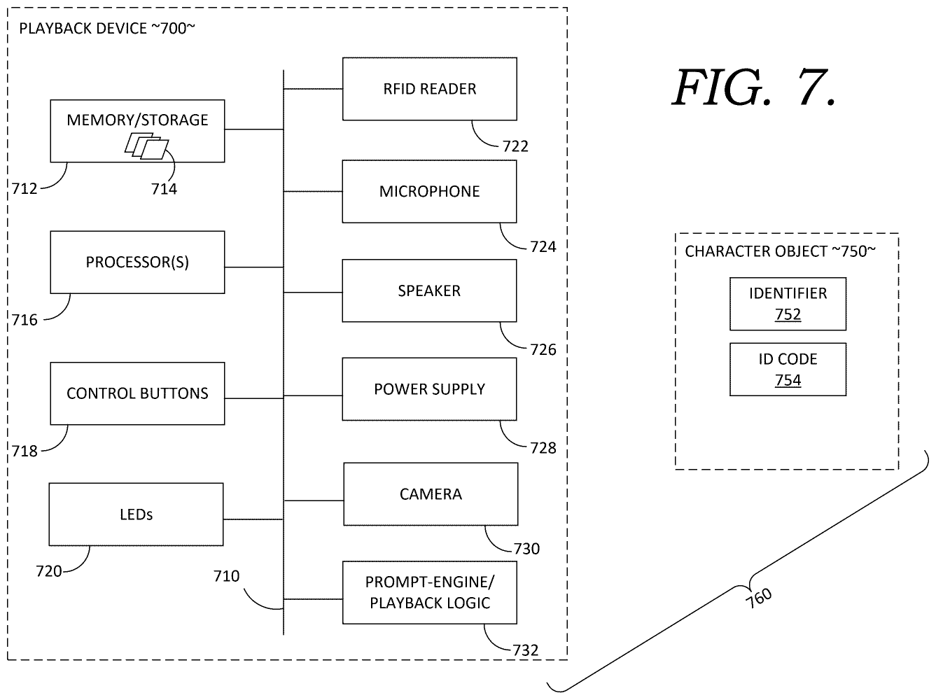

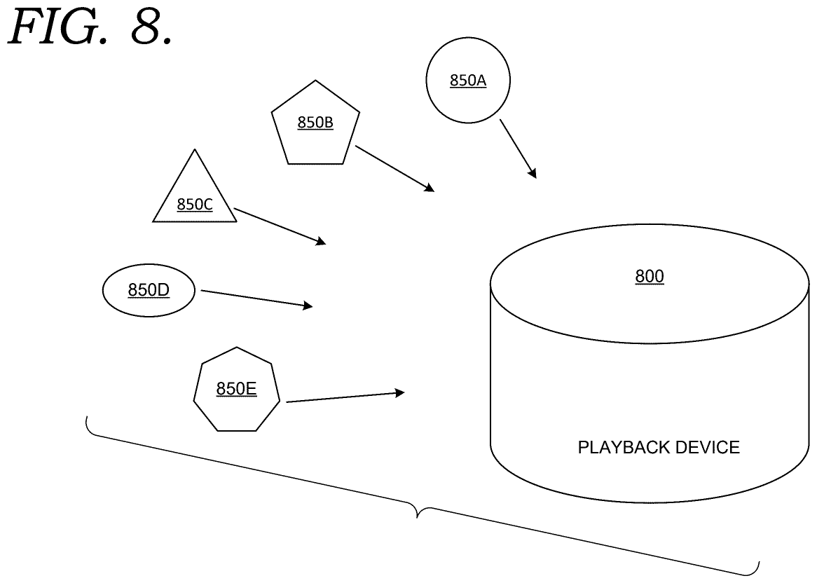

Another aspect of the disclosed technology relates to intelligently presenting a digital presentation based on a plurality of proximity inputs. For explanation's sake, a proximity input is referred to herein as character object (or “character” or “cast member” for short). As will be explained in greater detail with reference to FIGS. 7 and 8, a character object 750 (or 850A-E) can take the form of any physical device with a near-field communication identifier (such as an RFID tag, NFC chip, etc.). Character objects trigger the presentation of a specific scene in one embodiment. The scene can be one of a many that are related to each other by a series in one embodiment. Thus, character objects can be thought of as cast members.

The scene (and attributes or variations thereof) presented by playback device 700 depend on a variety of aspects of the character objects brought within a close proximity of playback device 700 (such as a few inches). For example, and as will be explained in more detail with reference to FIG. 8, playback device 800 presents a first scene if character objects 850A and 850B are brought near to it. It 800 presets a different scene if character objects 850A, 850B, and 850C are brought near to it. It 800 could begin presenting a third scene if character object 850A brought near and then transition to a fourth scene if character 850B is subsequently brought near while the third scene was being played, and the fourth scene could be a different scene than the first scene—thus, the scenes are different from when the two are brought near at the same time versus at different times in one embodiment.

Likewise, the fourth scene presented could transition to a fifth scene upon the removal of one of characters 850A or 850B, and the fifth scene could be different from the others, including a scene whereby both characters were simultaneously brought near to playback device 800.

Similarly, a still different scene would be presented in the presence of three characters versus four versus five.

These features will be explained in more detail after an explanation of the playback device and character objects.

FIG. 7 depicts a block diagram of an illustrative playback device 700 and of a character object 750, which interacts with playback device 700. In one embodiment, these are similar in makeup to the components of FIG. 1. In one embodiment, playback device 700 includes one or more memory or storage media 712. This can include a computer-storage media such as solid-state storage media, an SD card, or other storage media. The storage media 712 is suitable for storing computer-executable instructions suitable for executing programmatic instructions to carry out the functional aspects of the invention. It 712 can also be used to store memory files 714. Memory files 714 can be audio or video files, such as .WAV, .MP3, .MOV, .MPEG or other types of audio of video files.

One or more processors 716 control reading, processing computer-executable instructions and facilitating output.

One or more control buttons 718 control functional aspects of embodiment of the invention. For example, a first control button can be used to control playback or receive information about memory files. In one embodiment, a first control button can perform a first function when pressed and released, a second function when held down for a certain duration, a third function when held down a different duration, and a fourth function when double pressed.

LEDs (or equivalents) 720 can provide status or feedback to a user. For example, it (or they) could blink to indicate that playback device 700 is playing a message, or remain lit to show the presence of power, or periodically blink to show charge, etc.

RFID reader 722 is suitable to read RFID tags (or similar near-field communication devices) when they are brought within a sufficient proximity to reader 722 (such as a few inches to a couple feet). It can facilitate providing power to enable a reading of a nearby RFID tag. Alternatively, reader 722 can read a QR code via camera 730 (if equipped with one).

Microphone 724 facilities recording audio. Speaker 726 outputs audio. Camera 730 can be used to record video or to recognize a pattern that takes the form of a unique identifier such as a QR code. In some embodiments, however, a camera is specifically not included (especially when greater simplicity is desired).

Power supply 728 can be one or more batteries or represents a constant power supply such as being plugged in or otherwise connected to an external source of power.

A prompt engine 732 (if included) includes prompts and prompt categories that prompt users to help them record meaningful memories. In one embodiment prompt engine 732 includes a set of computer-executable instructions embodied on memory 712 and is adapted to emit a plurality of audible prompts via speaker 726. The base station can store multiple recordings. Prompt engine 732 can take on a variety of forms.

In a first format, prompt engine 732 could be token driven. This embodiment could include an immutable list of prompts identifiers. This list would define all possible prompts for the life of a collection. Playback device 700 includes pre-recorded prompts for every prompt type on this list in one embodiment. When a user brings a character object 750 close to playback device 700), playback device 700 retrieves the respective prompt identifier and implements the corresponding prompt.

A second format of prompt engine 732 is base-station driven. This embodiment includes an immutable list of character objects. This list identifies entities with stories to record into a base station (i.e., a mom, son, best man, teacher, etc.). The playback device 700 includes a pre-recorded prompts for every type on the list in one embodiment. When a character object is brought close to playback device 700, it retrieves the respective type identifier and performs the corresponding prompt.

A third format that prompt engine 732 may assume is user-guide oriented. For example, a sheet of paper or a book (etc.) can be included. The guide includes inspirations and examples for a user to use the system.

A fourth format that prompt engine 732 includes online aspects. In this embodiment, one or more web pages could be utilized, reachable via a unique identifier on the base station, station as a QR code. Scan the QR code directs the user to a web page, application, etc. that includes instructions or content relevant to the base station. This can provide an alternative way to view the memories stored on the base station or play them back.

The prompts of prompt engine 732 can also be realized in a variety of ways. Prompts can be stored in playback device 700. They are presented to a user, asking specific questions based on the accessory brought to the base station. A database of prompts can be stored in the base station or, alternatively or additionally, in an accessory 150. In still other embodiments, an application can be used to present prompts. This can include a gamified experience. For example, each person of a couple could be asked the same question separately; but they would be allowed to hear each other's answers only after both have recorded each's answer.

Reference numeral 732 refers also to playback logic. Playback logic 732 facilitates presenting scenes based on the presence, introduction, absence, withdrawal, etc. of character objects 750. A scene can be audio only in embodiments where simplicity is desired and where a screen and other components are intentionally not included. A scene could also be a mixture of audio and video in embodiments that a screen is desired. In some embodiments, playback device 700 can wirelessly stream data to a receiving device (such as a smartphone or compatible television) that is useable to present the scene on the receiving device. In one embodiment, playback logic 732 includes computer-executable instructions embodied on one or more memories that, when executed by at least one processor, cause the playback device to perform the steps described herein.

In one embodiment, playback logic 732 presents scenes based on the simultaneous presence of character objects 750. In some embodiments, playback logic 732 transitions scenes based on the introduction or withdrawal of character objects. The scenes can be the same or different as if the character objects were initially presented together or separate—or the scenes can be different.

Many variations are possible. For example, additionally or alternatively, a first character object and second character object could be reciting dialogue from a movie scene. Then character one is removed, and within a defined time period, character three is replaced in character two's spot. In that scenario, there could be a transitional dialogue from character two that makes a smooth transition from character two talking with character one, to character two now talking with character three. This would be less choppy. In some embodiments, playback device 700 is in an always-on state, it is always able to notice any changes regarding the presence or absence of character objects. It can also understand timing. Playback content could depend on whether the first character is still present and for how long it has gone without someone to talk to. In this way, the playback sound could be the start of an entirely new conversation in an entirely new part of a scene in a given situational context (such as a series, movie, book, song, album, play, historical event, family event, personal memory, etc.) if playback device 700 was previously sensing two character objects 750, then can no longer sense the second object, then notices a third object. If a certain threshold of time has passed since there were two character objects observable by the playback device 700, then it could transition to an entirely new timepoint for dialogue between one of the initial characters and a new character, rather than try to transition smoothly into the dialogue that was previously happening.

The items of playback device 700 are coupled to each other by one or more busses 710.

A block diagram of character object 750 shows it including an identifier 752 (such as RFID tag), an ID code 754, metadata, and one or more data files (not shown) in one embodiment. Identifier 752 uniquely identifies character object 750 to base unit 700. In some embodiments, it is unique when compared to other, different character objects, but not unique when compared to the same characters. It can be an RFID tag, QR code, or other unique identifier. Metadata can describe character object 750 or the data it contains, such as a data file.

Playback device 700 and character object 750 can take on a variety of physical forms. For example, playback device 700 could be an ornament, molded, die-cut plastic, papercraft product, a greeting card, a box, a cylinder, or any other shape or physical form. It is a tangible device that can be touched and interacted with. It can be themed, such as a snowflake, a seashell, a snow globe, a trophy etc.

The design of playback device 700 is intentionally kept simple in some embodiments. It is not meant to have the functionality of a computer or smartphone.

Turning now to FIG. 8, an illustrative set of character objects 850A-E and playback device 800 are shown in accordance with one aspect of the disclosed technology. This is an abstracted representation of features of the disclosed technology. More concrete examples will be provided later.

Each character object 850A-E includes an RFID tag (or equivalent), enabling playback device 800 to sense the presence of each when they are within a close proximity. Playback device 800 is always on in this embodiment. It is always able to sense the presence or absence of any character object 850A-E. In one embodiment, an RFID tag does not emit RF (radio frequency) transmissions using a source of power internal to the character object. Thus, the character object is not powered by a battery or similar. Or, if it is, that power is used for unrelated functions like light source. But the power source does not cause radio transmissions from the character object. The character objects are passive in one embodiment.

In one embodiment, character objects 850A-E are fixed. That is the full superset of possible characters associated with a given series. While playback device 800 may take on any number of forms, and its number is unlimited, each playback device in a series will never be able to respond to a character object besides 850A-E (of course, there could be fewer or many more than the five illustratively shown). Similarly, the number of series is unlimited.

Each character object 850A-E represents character in a situational context, such as a series, character in a book, a movie, a song, etc. (as mentioned). The series does not have to be limited to widely known pop-culture items. That is only one embodiment. A series could be personal to a user, where playback device 800 is specific to the user and character objects 850A-E are family members, for example. In that scenario, playback device 800 would be configured to playback scenes related to a personal life event, such as a family vacation, a graduation, a personal achievement, a sporting event, a birthday, a party, a celebration, a family gathering, a reunion, and the like. Playback device 800 would play a first memory when character object 850A and 850B (corresponding to a mother and a daughter) are brought close. It would present a different presentation when character object 850C (a father) is likewise brought near. It would present still a different aspect of the trip when character object 850D (another child or perhaps a grandparent) is also brought near. Moreover, playback device 800 would vary a presentation in real time as a new character object is introduced or withdrawn in one embodiment. For this use case, perhaps playback device 800 took the form of a large seashell. If the family visited Paris, perhaps it was a figurine of the Eifel Tower. If they visited Rome, perhaps it was a small replica of the Colosseum. It could also be a greeting card or papercraft with a built-in speaker. The card would play different audio clips based on which character objects were present.

Returning to the use case where a series reflects a popular pop-culture item or set of items, we now provide a more concrete example against the backdrop of a specific situational context, here, the movie “It's a Wonderful Life” directed by Frank Capra. The movie depicts a man (George Bailey) who gave up his personal dreams in to help others, falls on difficult times, and is ultimately helped in his time of need by those whom he helped. Mary is George's wife and champion. Uncle Billy is portrayed as a lovable but absent-minded man. Mr. Potter is focused on wealth and earthly possessions and tries to hire George for his own gain. Clarence is portrayed as a guardian angel in physical form.

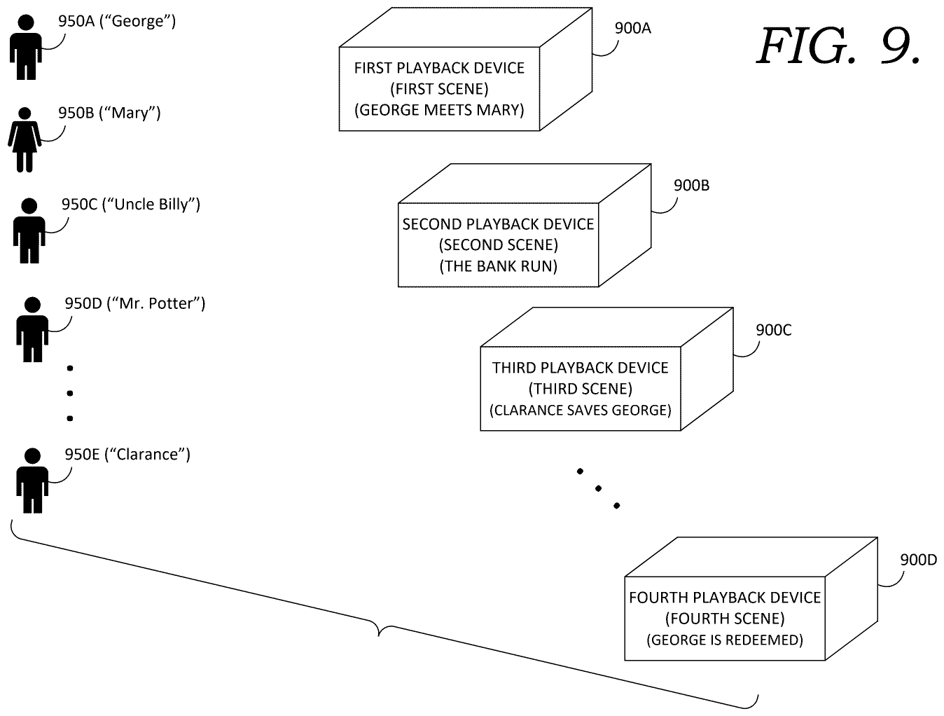

For explanatory purposes and with reference to FIG. 9, George will be represented as character object 950A, Mary as 950B, Uncle Billy as 950C, Mr. Potter as 950D, and Clarence as 950E. If desired, far more character objects could be represented, such as his brother (whom George saved at the expense of hearing in one hear), each of George's four children, George's father (who stood up to Mr. Potter), Mr. Gower (whom George helped save from being sent to prison for accidentally poisoning a customer), and more. This example is limited to five characters only for the sake of simplicity and for explanatory purposes.

In one embodiment, the number of character objects is immutably fixed. Here, the number would be fixed at five. In such embodiments, code and configuring scenes is greatly simplified because playback devices only need to know how to interact with a known set of character objects.

Four illustrative playback devices (900A-D) are shown. Each respectively corresponds to a different scene. The number of scenes is not limited. Although each playback device is abstractly shown as a box, they each could take on a physical form related to its scene in one embodiment. Each illustrative scene and interactions will be discussed below.

First scene 900A would depict George meeting Mary. Thus, first playback device 900A might take the form of a heart, of a high-school gymnasium (where they met, at dance), or a school, etc. Presume playback device 900A is a plastic ornament that looks like a high school. Bringing George 950A near first playback device 950A may cause it to begin playing audio from George related to him at the dance. If Mary 950B is brought near to first playback device 900 while George 950A is talking, then the content of his audio transitions in one embodiment. It may smoothly (or abruptly, if desired), transition to “Oh, why don't you stop annoying people?” Mary 950B might say “You look at me as if you didn't know me.” And the two would further interact with each other, and first playback device 900A would continue to play audio from George and Mary related to them meeting a high-school dance.

Similarly, if George 950A and Mary 950B were brought close to first playback device 900A at the same time, then the scene might start with Mary 950 saying “You look at me as if you didn't know me.” The scene could continue with dialogue related to the scene.

Removing Mary from the scene (e.g., moving character object 950B away from first playback device 900A) could cause a change in the scene. For example, George might say “Where did she go?” If Mary 950B is re-introduced into the scene within a threshold amount of time, the dialogue might include certain content. Mary 950B might say “sorry, I got tapped out.” But if too much time passes, then re-introducing Mary 950 into first scene 900A would re-start the sequence.

Although the number of scenes is unlimited, coding the presentation of scenes would be simplified because each one needs to account only for interactions between, in this case, five characters—all of which are known.

If, while George 950A and Mary 950B were nearby first playback device 900A, and Uncle Billy is also brough near to it, then George 950A might transition to say, “Hi Uncle Billy, you remember Mary, don't you?” Because Uncle Bill is present (with George), Mary 950B might say “George has told me so much about you Uncle Billy.”

First playback device 900A would play a different scene for each combination of character objects in one embodiment. It could vary audio playback based on new characters joining or leaving and could vary playback based on durations of presence and absence of each character object.

Second playback device 900B presents a different scene. In this example, it would present the “bank run” scene. That scene would relate to when George prevents his bank—the only alternative to Mr. Potter's—from being shut down by providing his own life savings as capital. George had wanted to travel the world since he was child. Freshly married to Mary, he is ready to finally be able to go beyond his small town. But the people of Bedford Falls are scared that they might not get their money from banks. A bank run ensues.

Thus, second playback device 900B may take a physical form of a bank (though it would take on other forms). Bringing George 950A close to second playback device 900B may cause it to play the voice of George pleading with people to not withdraw large amounts, lest they lose the only alternative to Mr. Potter. But introducing Mary 950B would lead to a valiant “How much do you need!?” The scene would conjure to the mind Mary being willing to use their own funds in this time of need. If playback device 900B was casting information to a remote device, such as a smartphone (not shown), it could present Mary holding the money up triumphantly. Removing Mary 950B may revert to George 950A making different arguments to the crowd. Introducing Mr. Potter 950D may lead to second playback device 900B outputting “I'll pay fifteen cents on the dollar.” Adding Uncle Billy 950 may cause playback device 900B to output the voice of Uncle Billy saying how much time they have until the bank can be closed.

Third playback device 900C presents still a different scene, where Clarance begins to save George. Clarance is a guardian angel portrayed as a human being. As George contemplates extreme hardship while looking in a river from a bridge, Clarance—unbeknownst to George—jumps in. He cries for help. George jumps in to save him. Latching onto a fleeting comment, Clarance grants George his wish of having never been born. This provides a chance for George to see how impactful his life was to so many people.

Thus, third playback device 900C may take the form of a star, a river, a bridge, or similar. Or it could be a greeting card, ornament, papercraft, etc. When George 950A is brought near, playback device 900C may play audio of George praying for help. If George 950A and Clarance 950E were presented together at third playback device 900C, then it 900C may play a dialogue between. If George 950A is removed, then third playback device 900C may play audio of Clarance speaking with other angels, asking for help. If Geroge 950A is re-introduced and brough near to third playback device 900C again, it could transition to playing a different audio/video message.

In like manner, fourth playback device relates to a different scene, such as when George is redeemed. After George is allowed to see what the world would have been like without him (Mary never getting married, his brother not be saved by George, the people his brother saved during a war not saved, his town overrun by greed, and more), he views his former problems with a different perspective. They do not seem as bad. The whole town and others come together to provide funds to George to help him address an accounting shortfall. He is redeemed, all happening at Christmas time.

Thus, fourth playback device 900D may look like a Christmas tree, a happy house, or similar. The presentation's fourth playback device 900D presents differ based on which of the character devices 950A-E are brought near, as previously explained.

In one embodiment, none of the playback devices 900A-D recognize any character object besides 950-E. In one embodiment, playback devices 900A-D are all associated with one series, event, book, move (as here), or similar. Although any number of series (etc.) can be created, each playback device of a series only recognizes the initially identified characters objects. For example, say only the five (950A-E) were initially programmed for and identified. And a company releases new scenes 900A-D over time. But then someone desires to introduce a new character, such as George's Brother. In one embodiment, too bad. That new character object could never cause any playback device 900A-900D to trigger or alter any presentation.

Thus, one embodiment of the disclosed technology is a system. The embodiment includes a first character object that is identifiable by a first near-field communications tag, wherein the first character object is associated with a first situational context. The embodiment also includes a second character object that is identifiable by a first near-field communications identifier, wherein the second character object is also associated with the first situational context. A first playback device is associated with the first situational context and that includes a speaker and one or more non-transitory computer-storage media having computer-executable instructions embodied thereon that, when executed by at least one processor, cause the playback device to perform a method. The method includes recognizing the first character object by the first near-field communications identifier when the first character is brought within a proximity of the playback device, wherein the proximity is 12 inches or fewer; recognizing the second character object by the second near-field communications identifier when the second character object is brought within the proximity of the playback device; presenting a first presentation based on the identification and proximity of the first and second character objects; and presenting a second presentation when the first character object or the second character object is no longer within the proximity of the playback device.

Another embodiment includes one or more non-transitory computer-storage media having computer-executable instructions embodied thereon that, when executed by at least one processor of a playback device, cause the playback device to perform a method. The method includes sensing that a first character object is within a proximity of the playback device. The first character object is passive in that it does not emit RF (radio frequency) transmission using an internal source of power. The playback device stores a plurality of presentable scenes that are all related to a common situational context. The method further includes, incident to sensing the first character object, presenting a first scene presentation based on the presence of only the first character object, wherein the first scene presentation is among the plurality of presentable scenes; sensing that a second character object is within the proximity of the playback device, wherein the second character object is passive in that it does not emit RF (radio frequency) transmission using an internal source of power; and incident to sensing the second character object, transitioning from presenting the first scene presentation to presenting a second scene presentation based on the sensing of the second character object, wherein the second scene presentation is among the plurality of presentable scenes.

Another embodiment includes a playback device. The playback device includes a body that does not include a display; a speaker; a processor; one or more memories; a set of scene presentations stored in the one or more memories, wherein each scene presentation in the set is related to each other by a common situational context; an RFID reader configured to identify a plurality of character objects, wherein each character object is identifiable by an RFID tag, and the number of different character objects among the plurality of character objects is immutable fixed; and one or more computer-executable instructions embodied on the one or more memories that, when executed, cause one or more of the scene presentations, without accessing the internet, to be presented based on which character objects are within a proximity of the playback device, wherein the proximity is fewer than 12 inches.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub combinations are of utility, may be employed without reference to other features and sub combinations, and are contemplated within the scope of the claims.

What is claimed is:

1. A system, comprising:
a first character object that is identifiable by a first near-field communications identifier, wherein the first character object is associated with a first situational context;
a second character object that is identifiable by a second near-field communications identifier, wherein the second character object is also associated with the first situational context;
a first playback device that is also associated with the first situational context and that includes a speaker and one or more non-transitory computer-storage media having computer-executable instructions embodied thereon that, when executed by at least one processor, cause the first playback device to perform a method that does not involve access to the internet comprising:
recognizing the first character object by the first near-field communications identifier when the first character object is brought within a proximity of the first playback device, wherein the proximity is 12 inches or fewer;
recognizing the second character object by the second near-field communications identifier when the second character object is brought within the proximity of the first playback device;
presenting a first presentation based on an identification and proximity of the first and second character objects;
presenting a second presentation when the first character object or the second character object is no longer within the proximity of the first playback device.

2. The system of claim 1, wherein the first or second near-field communications identifier includes one or more of the following:
an RFID (radio frequency identification) tag, or
an NFC (near field communication) tag.

3. The system of claim 1, wherein the first situational context relates to one or more of the following:
a movie;
a book;
a song;
a poem;
a theatrical production;
an historical event;
a time genre; or
a television series.

4. The system of claim 1, wherein the first situational context relates to a personal life event.

5. The system of claim 4, wherein the personal life event includes one or more of the following:
a family vacation,
a graduation,
a personal achievement,
a sporting event,
a birthday,
a party,
a celebration,
a family gathering, or
a reunion.

6. The system of claim 1, wherein the first character object or the second character object take one or more of the following forms or combinations thereof:
a figurine;
an ornament;
a leaf; or
a keychain.

7. The system of claim 1, wherein the first playback device includes one or more of the following:
an ornament;
a greeting card;
a papercraft object; or
a plastic device.

8. The system of claim 1, wherein the proximity is six inches or fewer.

9. The system of claim 1, wherein the first playback device is configured to detect a fixed set of character objects and cannot detect other character objects besides those in the fixed set.

10. The system of claim 1, wherein the method further comprises presenting a third presentation when a third character object is brought within the proximity of the first playback device, wherein the third presentation is different from the first and second presentations.

11. The system of claim 1, wherein the method further comprises presenting a subsequent presentation based on one or more of the following:
withdrawing the first or second character object;
reintroducing the first or second character object;
reintroducing the first or second character object withing a certain amount of time after withdrawing it; or
sensing a presence of a subsequent character object that is different from the first or second character object.

12. One or more non-transitory computer-storage media having computer-executable instructions embodied thereon that, when executed by at least one processor of a playback device, cause the playback device to perform a method that does use the internet, the method comprising:
sensing that a first character object is within a proximity of the playback device, wherein the proximity is 12 inches or fewer, wherein the first character object is passive in that it does not emit RF (radio frequency) transmission using an internal source of power, and wherein the playback device stores a plurality of presentable scenes that are all related to a common situational context;
incident to sensing the first character object and without accessing the internet, presenting a first scene presentation based on a presence of only the first character object, wherein the first scene presentation is among the plurality of presentable scenes;
sensing that a second character object is within the proximity of the playback device, wherein the second character object is passive in that it does not emit RF (radio frequency) transmission using an internal source of power; and
incident to sensing the second character object, transitioning from presenting the first scene presentation to presenting a second scene presentation based on the sensing of the second character object, wherein the second scene presentation is among the plurality of presentable scenes.

13. The media of claim 12, wherein the playback device is configured to sense a fixed set of character objects and no others.

14. The media of claim 12, wherein the transitioning from the first scene presentation to the second scene presentation is a smooth transition that contextually adapts the first scene presentation to the second scene presentation.

15. The media of claim 12, wherein the transitioning from the first scene presentation to the second scene presentation is an abrupt transition that beings presenting the second scene presentation.

16. The media of claim 12, wherein the method further comprises presenting a subsequent presentation based on one or more of the following:
withdrawing the first or second character object;
reintroducing the first or second character object;
reintroducing the first or second character object withing a certain amount of time after withdrawing it; or
sensing a presence of a subsequent character object that is different from the first or second character object.

17. The media of claim 12, wherein each of the first and second scene presentation are respective segments of audio.

18. An offline system, comprising:
a physical device comprising a processor, memory, an RFID reader, a prompt engine, a microphone, and a speaker, wherein the prompt engine includes a set of computer-executable instructions embodied on the memory that is adapted to emit a plurality of audible prompts via the speaker, wherein the physical device does not include a camera; and
wherein the memory includes one or more computer-executable instructions that, when a specific RFID tag is placed within a sufficiently close proximity to the RFID reader, cause the prompt engine, without accessing the internet, to play a plurality prompts that prompt a user to record an audio file that is associated with the RFID tag.

19. The system of claim 18, further comprising a plurality of accessory objects that are each associated with a respective RFID tag such that when any one of the plurality of accessory objects is brought within a sufficiently close proximity to the RFID reader, it causes a specific audio file to be played that is associated with one of the plurality of accessory objects.
